(19) United States
(12) Patent Application Publication
(10) Pub. No.: US 2014/0340200 A1
(43) Pub. Date: Nov. 20, 2014

(54) Electronic Device and Method for Starting Electronic Device Through Remote Control

(71) Applicant: Fortune Advance Development Limited, British Virgin Islands (GB)

(72) Inventor: Sheng-Yang HUANG, Harvey (AU)

(73) Assignee: Fortune Advance Development Limited, British Virgin Islands (GB)

(21) Appl. No.: 13/897,458

(22) Filed: May 20, 2013

(51) Int. Cl. G05B 1/03

(52) U.S. Cl. CPC G05B 1/03
USPC 340/12.23

(57) ABSTRACT

An electronic device and a method for starting the electronic device through a remote control are disclosed. In the method, a processing circuit is set into a low power state, and whether a remote control data is received is detected. The remote control data received is compared with the pre-determined logic value, and the processing circuit is powered on when the remote control data is equal to the pre-determined logic value.

### BACKGROUND

1. Field of Invention

The present invention relates to a method for starting an electronic device. More particularly, the present invention relates to a method for starting an electronic device through a remote control.

2. Description of Related Art

A wide variety of consumer electronic devices have been able to be powered from AC/DC sources, such as an electrical outlet at home. Some of these consumer electronic devices may be operated remotely, i.e., operated at a distance from the device, with a remote control. The remote control is normally a hand-held device that provides an interface, such as a keypad, touchpad or the like, for a user to select functions of the corresponding device or devices to be controlled. Also, almost all the remote controls are wireless, battery-powered devices to facilitate the portability, such that the user can control the corresponding device(s) from the place other than where the device locates. A wireless remote control is commonly configured to communicate with the to-be-controlled device(s) via various known wireless communication modes, such as infrared, radiowave, Bluetooth, WiFi, or the like.

The devices are usually in a standby mode when not in operation. In the standby mode, these devices keep consuming power. Further, some devices continue to perform certain operations even if in the standby mode. For example, a set top box (STB) may keep monitoring its receiver or other input in the standby mode.

Another types of electronic devices are usually provided with a wake-up function which allows some parts to be activated from a low power state upon receiving a request. In order to allow those parts to be woken up through request, the electronic device needs to detect the request; polling is usually used to detect the request. Sometimes, the circuitry to be woken up also needs a certain level of power so as to receive the wake-up request. These actions all result in the increase in power consumption.

### SUMMARY

According to one embodiment of the present invention, a method for starting an electronic device through a remote control is disclosed. In the method, a processing circuit is set into a low power state, and whether a remote control data is received is detected. The remote control data received is compared with the pre-determined logic value, and the processing circuit is powered on when the remote control data is equal to the pre-determined logic value.

According to another embodiment of the present invention, an electronic system is disclosed. The electronic system includes a first electronic device which processes data and a plurality of instructions. The first electronic device includes a remote control signal receiver, a power management controller, and a processing circuit. The remote control signal receiver receives a remote control data.

The power management controller which controls power based on the remote control data received by the remote control signal receiver includes a storage device and a logic circuit. The storage device is configured to store a pre-determined logic value. The logic circuit is configured to compare the pre-determined logic value and the remote control data received. The processing circuit is electrically connected to the power management controller and is controlled in power by the power management controller. The processing circuit is powered on when the pre-determined logic value and the remote control data received are equal.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of an electronic system according to one embodiment of the present invention;

FIG. 2 is a block diagram of an electronic system according to another embodiment of present invention;

FIG. 3 is a flowchart of a method for starting an electronic device through a remote control according to one embodiment of the present invention; and

FIG. 4 is a flowchart of a method for starting an electronic device through a remote control according to one embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The following embodiments compare a pre-determined logic value with a received remote control data, and a processing circuit is set into a low power state and is powered on to operate only if the remote control data received is equal to the pre-determined logic value. The power consumption is thus reduced.

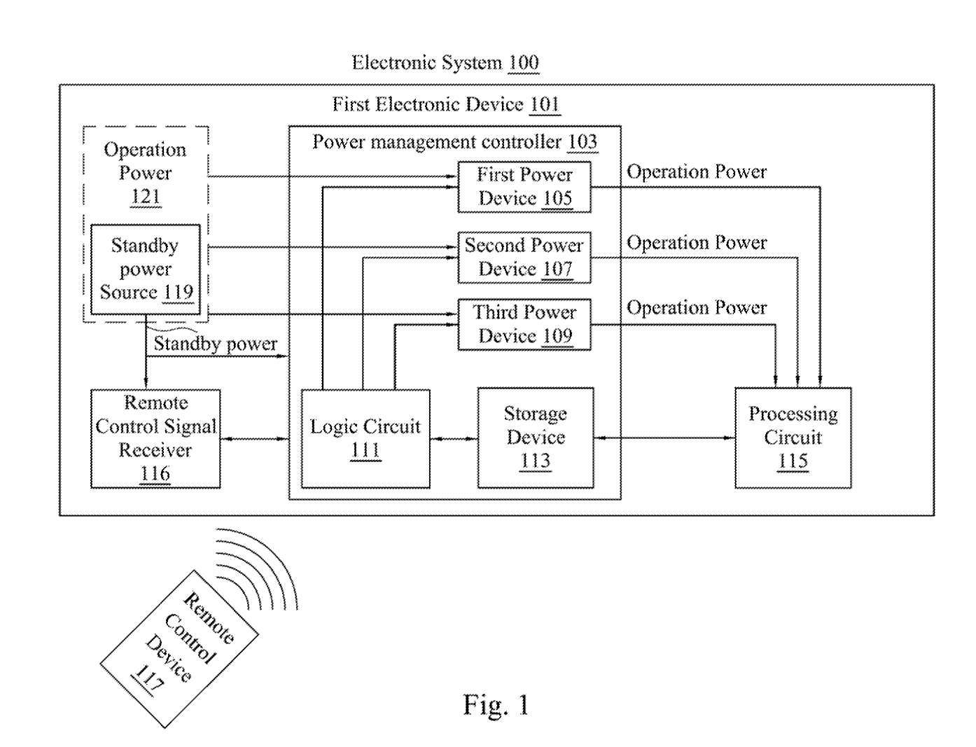

FIG. 1 is a block diagram of an electronic system according to one embodiment of the present invention. The electronic system 100 includes a first electronic device 101 and a second electronic device such as a remote control device 117.

The first electronic device 101 can be any kinds of circuits or products that can process data and instructions. For example, the first electronic device 101 can be a smart TV, a system unit of a desktop computer, a processing part of a notebook, or a processing part of a smart phone. The first electronic device can also be a videocassette recorder, a digital video disk player, a stereo device, a digital video recorder, or a game station.

The first electronic device 101 includes a power management controller 103 controlling power states based on remote control data received and a processing circuit 115 electrically connected to the power management controller 103.

The power management controller 103 includes a storage device 113 and a logic circuit 111. The storage device 113 is configured to store a pre-determined logic value. The storage device 113 can be all types of non-volatile memories such as a flash memory or an electrically-erasable programmable read-only memory (EEPROM) while the storage device 113 can also be all types of volatile memories such as registers, flip flops, or SRAMs (static random-access memories). The logic circuit 111 is configured to compare the pre-determined logic value with the remote control data received. The logic circuit 111 usually includes a plenty of flip flops and combination circuits for arithmetic computing, such as and gates, or gates, nor gates, etc. . . .

The processing circuit 115 is configured to process a plenty of instructions and data, such as video data and audio data, in which the processing circuit 115 is set to a low power state by the power management controller 103, such as a power off state or a sleep state, after the electronic system finishes initialization. In this embodiment, the low power state can be a power off state or a sleep state, and the power off state is preferred. The processing circuit 115 is powered on from the low power state to an operation state by the power management controller 103 only when the remote control data received is equal to the pre-determined logic value.

Therefore, the processing circuit 115 does not need to standby in order to receive the remote control data, such that the power consumption is reduced. In fact, the processing circuit 115 is electrically connected to the power management controller 103 and is controlled in power by the power management controller 103. With such mechanism, the processing circuit 115 does not consume power when it is set to the low power state, such that the power consumption is further reduced.

In addition, the power management controller 103 further includes a first power device 105, a second power device 107, and a third power device 109 electrically connected to the logic circuit 111 and the processing circuit 115. These power devices, such as DC-DC converters, supply power to the processing circuit 115 based on the comparison of the remote control data and the pre-determined logic value. When the remote control data and the pre-determined logic value are compared to be equal, the power devices are first turned on, then the processing circuit 115 is woken up or powered on, and the power devices provide operation power for the processing circuit 115, such that the power consumption is reduced.

The first electronic device 101 further includes a remote control signal receiver 116 and an operation power 121 which employs a standby power source 119 for providing power for the remote control signal receiver 116. The remote control signal receiver 116 is a circuit to receive several kinds of remote control data, such as an infrared receiver, a blue tooth receiver, a wireless communication receiver, or a WIFI receiver. In detail, the remote control signal receiver 116 might receive a remote control signal in first and demodulate the remote control signal to extract the remote control data.

The second electronic device, such as the remote control device 117, is a circuit or a product which can output the remote control data in turn to power on the processing circuit 115 of the first electronic device 101 from the low power state. The processing circuit 115 can be powered on from a power off state; alternately, the processing circuit 115 can also be woken up from a sleep state. In this embodiment, the remote control device 117 can be an infrared remote controller, a blue tooth remote controller, a 2.4 GHz wireless communication device, or a WIFI remote controller. The remote control device 117 can also be a videocassette recorder remote controller, a digital video disk player remote controller, a stereo device remote controller, a digital video recorder remote controller, or a game station remote controller.

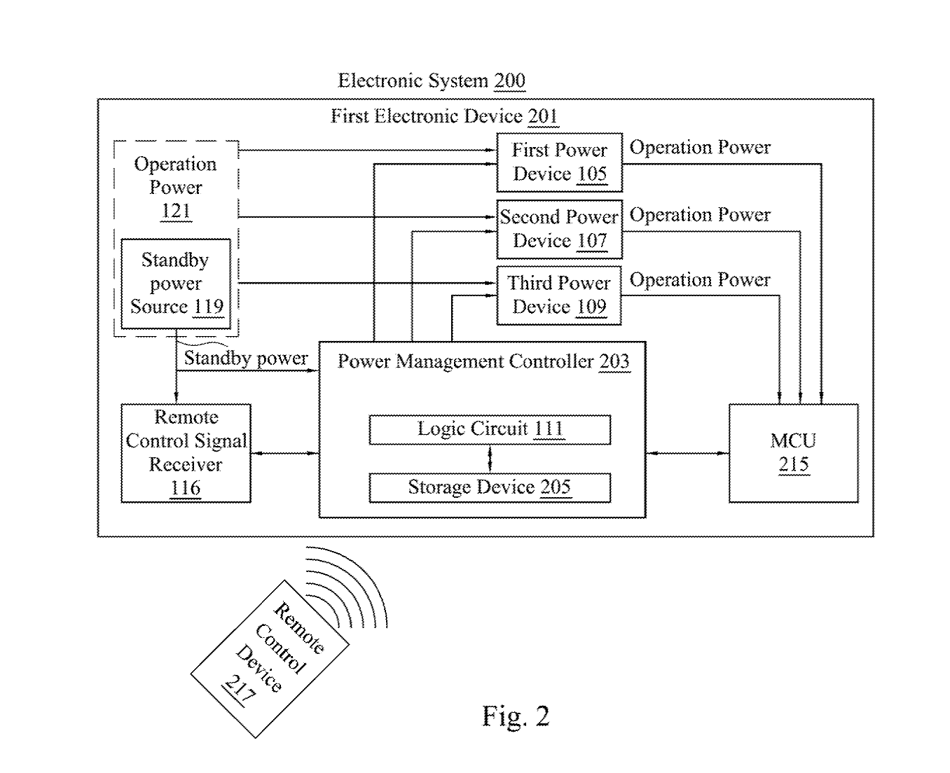

FIG. 2 is a block diagram of an electronic system according to another embodiment of present invention. The electronic system 200 includes a first electronic device 201 and a second electronic device such as a remote control device 217.

As depicted in the description of FIG. 1, the first electronic device 201 can be any kinds of circuits or products that can process data and instructions. The first electronic device 201 includes a power management controller 203 controlling power states based on remote control data received from the remote control signal receiver 116 and a micro control unit (MCU) 215 electrically connected to the power management controller 203. In this embodiment, the first power device 105, the second power device 107, and the third power device 109 are located beyond the power management controller 203 and are electrically connected to the power management controller 203 through wires.

The micro control unit 215 can provide a processor based mixed-signal application integrated circuit that is typically referred to as a system on a chip (SOC). Typically, a processor is provided of the 8051 type, a conventional processor, with memory such as Flash. These SOC integrated circuits are typically directed toward instrumentation type applications that requires interface with sensors and the such, and which can provide some processing of the information from these sensors in a digital domain.

In some applications of MCU based SOCs, there is a requirement for a low power mode of operation. Thus, these SOCs have what is termed a “sleep mode” associated therewith. The sleep mode allows the SOC to be placed in a very low power mode of operation, in which substantially all operations are suspended or halted to conserve power. There are a number of ways to implement the sleep mode of operation. The first is a complete power down of the chip, in which the configuration information and the such can be stored in the on-chip memory prior to power down. This is the lowest power mode of operation, since there is virtually no current drawn when the chip is powered down.

The power management controller 203 includes a logic circuit 111 as described in embodiment of FIG. 1 and a storage device 205. The storage device 205 is configured to store a pre-determined logic value. The storage device 205 can be a non-volatile memory or a volatile memory such as registers, flip flops, SRAM. When the electronic system 200 is started for the first time, a pre-determined logic value, such as 00FF (Hex) is set, such as loaded from MCU 215 to the storage device 203 if necessary. In another way, the pre-determined logic value can be set into the storage device 205 through a recording process during the manufacturing of the electronic system 200. The MCU 215 is powered off to reduce the power consumption, and the MCU 215 does not consume power until it is woken up by the logic circuit 111 to enter the operation state. As described in the embodiment of FIG. 1, when the logic circuit 111 compares the pre-determined logic value stored in the storage device 205 with the received remote control data and determines these two values are equal, the power management controller 203 will turn on the power devices (first power device 105, second power device 107, or the third power device 109) in first, then the power devices will supply operation power for the MCU 215 to operate. In the operation state, the MCU 215 is supplied with a higher voltage or a larger current.

The second electronic device, such as the remote control device 217 is a circuit or a product which can transmit a signal to power on the MCU 215 of the first electronic device 201 from the low power state, such as a power off state or a sleep state. In this embodiment, the remote control device 217 can be a videocassette recorder remote controller, a digital video disk player remote controller, a stereo device remote controller, a digital video recorder remote controller, or a game station remote controller.

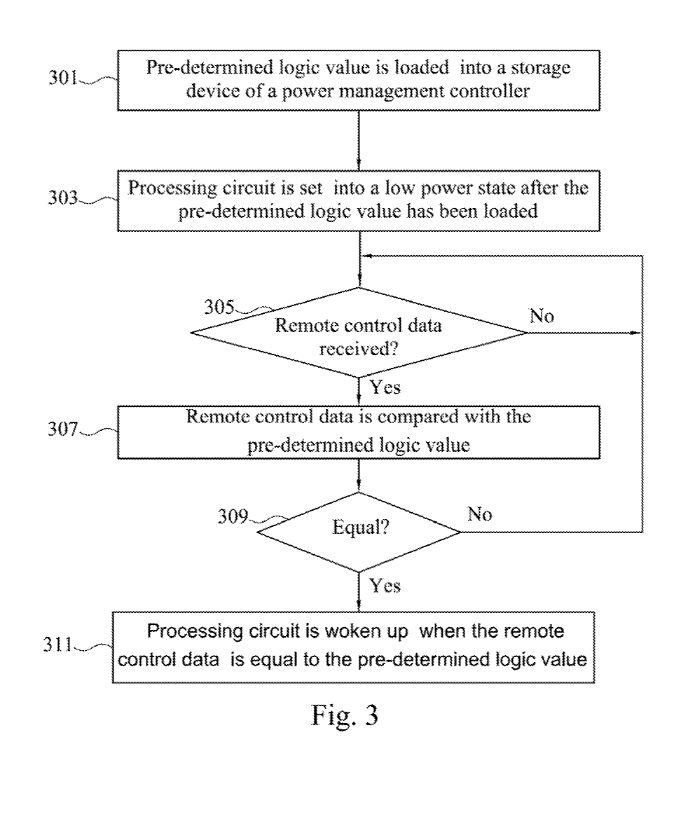

FIG. 3 is a flowchart of a method for starting an electronic device through a remote control according to one embodiment of the present invention. In the method, a pre-determined logic value is loaded into a storage device of a power management controller (step 301). In detail, the pre-determined logic value can be loaded from the processing circuit into the storage device when the electronic system is started for the first time.

Then the processing circuit is set into a low power state after the pre-determined logic value has been loaded (step 303). In this embodiment, the processing circuit is set into a power off state or a sleep state, and standby power is no longer required for the processing circuit, which further reduces the power consumption.

After step 303, a remote control data is detected if it is received (step 305). In this step, the detection is performed continuously until the remote control data is received. When the remote control data is received, it is compared with the pre-determined logic value (step 307) and is determined if it is equal to the pre-determined logic value (step 309). In this embodiment, since power states are controlled according to the value of the remote control data, the power management controller does not need to poll operation states of the processing circuit. Specifically, the remote control data and the pre-determined logic value are not compared through a software but through logic circuits such as combinational circuit and sequential circuit. Therefore, the MCU is not required for the comparing purpose. If these two data are determined to be equal, the processing circuit is power on from the low power state and performs the starting sequence (step 311).

The above embodiments set a pre-determined logic value to be compared, and the processing circuit is set into a low power state, which saves the power. The processing circuit is powered on only if a remote control data equal to the pre-determined logic value is received. By this way, the processing circuit is no longer required to standby, which further reduces the power consumption.

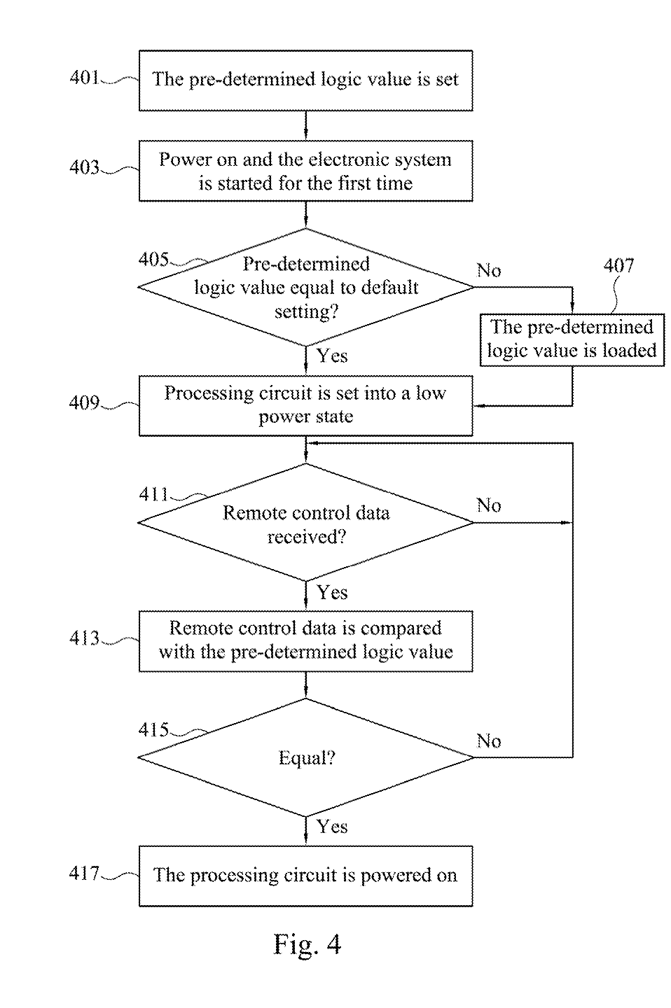

FIG. 4 is a flowchart of a method for starting an electronic system through a remote control according to one embodiment of the present invention. In this embodiment, the electronic system includes a power management controller and a processing circuit controlled by the power management controller. In the method, the pre-determined logic value is set in first (Step 401), that is, the pre-determined logic value is inherently built in. Specifically, it can be set by an user. For example, the pre-determined logic value can be set to 0x0ff (Hex) by an user through recording. The pre-determined logic value can be set through recording during the manufacturing of the electronic system. After that, the electronic system is powered on and is started for the first time (step 403).

Further, the set pre-determined logic value is checked if it is equal to a default setting (step 405). When the set pre-determined logic value is equal to the default setting, the loading step is not necessary and is skipped. When the set pre-determined logic value is not equal to the default setting, the pre-determined logic value is loaded from the processing circuit into the storage device of the power management controller (step 407). Subsequently, the processing circuit is set to a low power state which can be a power off state or a sleep state (step 409).

Next, a remote control data is checked if it is received (step 411), and the remote control data received is compared with the pre-determined logic value (step 413) and is checked if they are equal (step 415). After that, the processing circuit is powered on when the remote control data is equal to the pre-determined logic value (step 417). Otherwise, the processing circuit is kept in the low power state.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for starting an electronic device through a remote control, the method comprising:
setting a pre-determined logic value into a storage device of a power management controller;
setting a processing circuit controlled by the power management controller into a low power state;
detecting whether a remote control data for switching the low power state is received;
comparing the remote control data received with the pre-determined logic value; and
powering on the processing circuit when the remote control data is equal to the pre-determined logic value.

2. The method as claimed in claim 1, wherein the pre-determined logic value is built into the storage device of the power management controller before the electronic system is started for the first time.

3. The method as claimed in claim 2, wherein the pre-determined logic value is built into the storage device through a recording process before the electronic system is started for the first time.

4. The method as claimed in claim 1, wherein the pre-determined logic value is loaded from the processing circuit into the storage device of the power management controller when the electronic system started for the first time.

5. The method as claimed in claim 1, wherein the remote control data is compared with the pre-determined logic value through a logic circuit.

6. The method as claimed in claim 1, wherein the power management controller does not poll operation states of the processing circuit.

7. The method as claimed in claim 1, wherein the low power state is a power off state or a sleep state.

8. An electronic system, comprising:
a first electronic device which processes data and a plurality of instructions comprising:
a remote control signal receiver for receiving a remote control data;
a power management controller which controls power based on the remote control data received by the remote control signal receiver, wherein the power management controller comprises:
a storage device configured to store a pre-determined logic value; and
a logic circuit configured to compare the pre-determined logic value and the remote control data received; and
a processing circuit electrically connected to the power management controller and power controlled by the power management controller, wherein the processing circuit is powered on when the pre-determined logic value and the remote control data received are equal.

9. The electronic system as claimed in claim 8, wherein the processing circuit is powered on from the low power state to an operation state when the remote control data is equal to the pre-determined logic value.

10. The electronic system as claimed in claim 8, wherein the storage device is a volatile-memory or a non-volatile memory.

11. The electronic system as claimed in claim 8, wherein the logic circuit comprises a plurality of flip flops and a plurality of combinational circuits.

12. The electronic system as claimed in claim 8, wherein the power management controller further comprises:
at least one power device electrically connected to the logic circuit and the processing circuit, wherein the power device controls power supplying for the processing circuit based on a comparison result of the remote control data and the pre-determined logic value.

13. The electronic system as claimed in claim 12, wherein the power device is a DC-DC converter.

14. The electronic system as claimed in claim 8, wherein the first electronic device is a TV, a system unit of a desktop computer, a processing part of a notebook, or a processing part of a smart phone.

15. The electronic system as claimed in claim 8, wherein the first electronic device is a videocassette recorder, a digital video disk player, a stereo device, a digital video recorder, or a game station.

16. The electronic system as claimed in claim 8, further comprising:
a second electronic device for outputting the remote control data which is taken for powering on the processing circuit of the first electronic device.

17. The electronic system as claimed in claim 16, wherein the second electronic device is an infrared remote controller, a blue tooth remote controller, or a WIFI remote controller.

18. The electronic system as claimed in claim 16, wherein the second electronic device is a videocassette recorder remote controller, a digital video disk player remote controller, a stereo device remote controller, a digital video recorder remote controller, or a game station remote controller.
